(19) United States
(12) Patent Application Publication
(10) Pub. No.: US 2016/0252883 A1
(43) Pub. Date: Sep. 1, 2016

(54) ELECTRONIC TIMEPIECE

(71) Applicant: Seiko Epson Corporation, Tokyo (JP)

(72) Inventor: Katsutoyo INOUE, Azumino (JP)

(21) Appl. No.: 15/052,095

(22) Filed: Feb. 24, 2016

(30) Foreign Application Priority Data
Feb. 27, 2015 (JP) 2015-038293

(51) Int. Cl. G04B 47/06; G04G 19/00; G04R 20/02

(52) U.S. Cl. CPC G04B 47/063; G04R 20/02; G04B 47/066; G04B 47/068; G04B 47/06; G04G 19/00

(57) ABSTRACT

An electronic timepiece includes a secondary battery, a solar cell, a noncontact charging circuit, a control circuit, a time measurement section that measures time, a time display section that displays the time measured by the time measurement section, a biological information measurement circuit that measures information on a biological body to which the electronic timepiece is attached, and a power supply voltage detection circuit that detects voltage across the secondary battery, and the control circuit enables the biological information measurement circuit only when the voltage across the secondary battery is higher than or equal to first voltage whereas enabling the time measurement section and the time display section irrespective of the voltage across the secondary battery.

### BACKGROUND

1. Technical Field

The present invention relates to an electronic timepiece.

2. Related Art

There is a known electronic timepiece of related art having advanced functions, such as a smartwatch. The wristwatch disclosed in JP-2010-240158 includes a vibration sensor and an atmospheric pressure sensor and can calculate energy consumption and display a result of the calculation.

Since an electronic timepiece of related art having advanced functions consumes a large amount of electric power, and all functions are disabled when battery voltage decreases, the basic function as a timepiece (time measurement function) cannot undesirably be maintained for a long period.

### SUMMARY

An advantage of some aspects of the invention is to provide an electronic timepiece capable of maintaining the basis function as a timepiece for a long period.

(1) An electronic timepiece according to an aspect of the invention includes a secondary battery, a plurality of charging sections that charge the secondary battery with electric power, a time measurement section that is driven with the electric power from the secondary battery and measures time, a biological sensor that is driven with the electric power from the secondary battery and measures information on a biological body to which the electronic timepiece is attached, and a time display section that displays the time measured by the time measurement section.

The electronic timepiece described above, which includes a plurality of charging sections, can maintain basic functions as a timepiece for a long period.

(2) The electronic timepiece according to the aspect of the invention may further include a voltage detection section that detects voltage across the secondary battery, and the biological sensor may be enabled only when the voltage across the secondary battery is higher than or equal to first voltage, but the time measurement section and the time display section may be enabled irrespective of the voltage across the secondary battery.

The electronic timepiece described above, in which the biological sensor is disabled when the voltage across the secondary battery is lower than the first voltage, can maintain basic functions (time measurement function and time display function) as a timepiece for a long period.

(3) The electronic timepiece according to the aspect of the invention may further include a reception section that receives a radio wave containing time information and a time correction section that corrects the time based on the time information received by the reception section, and the reception section and the time correction section may be enabled irrespective of the voltage across the secondary battery.

The electronic timepiece described above can maintain correct time measurement by reception of a radio wave containing time information even when the voltage across the secondary battery decreases.

(4) In the electronic timepiece according to the aspect of the invention, the reception section may include at least one of a GPS reception circuit that receives a GPS satellite signal and a radio wave reception circuit that receives a standard radio wave.

The electronic timepiece described above can maintain correct time measurement by reception of a GPS satellite signal or a standard radio wave each containing time information even when the voltage across the secondary battery decreases.

(5) The electronic timepiece according to the aspect of the invention may further include a wireless communication circuit that transmits and receives information to and from an external apparatus and a time correction section that corrects the time based on time information received from the external apparatus, and the wireless communication circuit and the time correction section may be enabled irrespective of the voltage across the secondary battery.

The electronic timepiece described above can maintain correct time measurement based on time information received from an external apparatus even when the voltage across the secondary battery decreases.

(6) The electronic timepiece according to the aspect of the invention may further include an acceleration sensor and a wireless communication circuit capable of transmitting information detected with the acceleration sensor to an external apparatus, and the acceleration sensor and the wireless communication circuit may be enabled irrespective of the voltage across the secondary battery.

The electronic timepiece described above can maintain the function of transmitting information detected with the acceleration sensor to an external apparatus even when the voltage across the secondary battery decreases.

(7) The electronic timepiece according to the aspect of the invention may further include an operation section and at least one of an atmospheric pressure sensor, a temperature sensor, a direction sensor, and a pulse sensor, and a sensor to be enabled irrespective of the voltage across the secondary battery may be allowed to be selected by operation of the operation section from the atmospheric pressure sensor, the temperature sensor, the direction sensor, and the pulse sensor.

The electronic timepiece described above allows a user to select a sensor to be enabled irrespective of the voltage across the secondary battery from the atmospheric pressure sensor, the temperature sensor, the direction sensor, and the pulse sensor, whereby convenience of the user can be improved.

(8) In the electronic timepiece according to the aspect of the invention, when the voltage across the secondary battery is lower than second voltage lower than the first voltage, at least part of a function of the time display section may be disabled.

The electronic timepiece described above, in which at least part of the function of the time display section is disabled when the voltage across the secondary battery is lower than the second voltage, can maintain the time measurement function for a long period.

(9) In the electronic timepiece according to the aspect of the invention, even when the voltage across the secondary battery is higher than or equal to the first voltage, disablement of the biological sensor may be allowed to be selected by operation of the operation section.

The electronic timepiece described above, which allows the user to select disablement of the biological sensor in a situation in which the biological sensor is not required to operate, can maintain the basic functions as a timepiece for a long period.

(10) The electronic timepiece according to the aspect of the invention may further include a remaining amount display section that displays the amount of remaining battery voltage of the secondary battery in the form of a relationship with the first voltage.

The electronic timepiece described above allows the user to grasp whether or not the biological sensor can be enabled.

(11) In the electronic timepiece according to the aspect of the invention, any one of the plurality of charging sections may include an operation section and convert energy produced by operation of the operation section into electric power for the charging.

The electronic timepiece described above, which allows the secondary battery to be charged without use of any external power supply, allows the biological sensor to operate as required even when the voltage across the secondary battery is low.

(12) In the electronic timepiece according to the aspect of the invention, any one of the plurality of charging sections may convert any one of optical energy, kinetic energy, thermal energy, and fuel energy into electric power for the charging.

The electronic timepiece described above, which allows the secondary battery to be charged without use of any external power supply, allows the biological sensor to operate as required even when the voltage across the secondary battery is low.

(13) In the electronic timepiece according to the aspect of the invention, any one of the plurality of charging sections may acquire electric power from an external power supply for the charging.

The electronic timepiece described above, which allows the secondary battery to be quickly charged with use of an external power supply, allows the biological sensor to operate as required even when the voltage across the secondary battery is low.

(14) The electronic timepiece according to the aspect of the invention may further include a tubular case made of a metal material, and the charging sections, the time measurement section, the biological sensor, and the time display section may be disposed in the case, and the time display section may include a dial and an indication hand.

The electronic timepiece described above can be an electronic timepiece having a high-grade exterior appearance.

### BRIEF DESCRIPTION OF THE DRAWINGS

The invention will be described with reference to the accompanying drawings, wherein like numbers reference like elements.

FIG. 1 is a plan view of an electronic timepiece according to a first embodiment.

FIG. 2 is a schematic cross-sectional view of the electronic timepiece according to the first embodiment.

FIG. 3 is a block diagram showing a circuit configuration of the electronic timepiece according to the first embodiment.

FIG. 4 describes voltage across a secondary battery.

FIG. 5 is a flowchart showing the procedure of the action of a control circuit.

### DESCRIPTION OF EXEMPLARY EMBODIMENTS

### First Embodiment

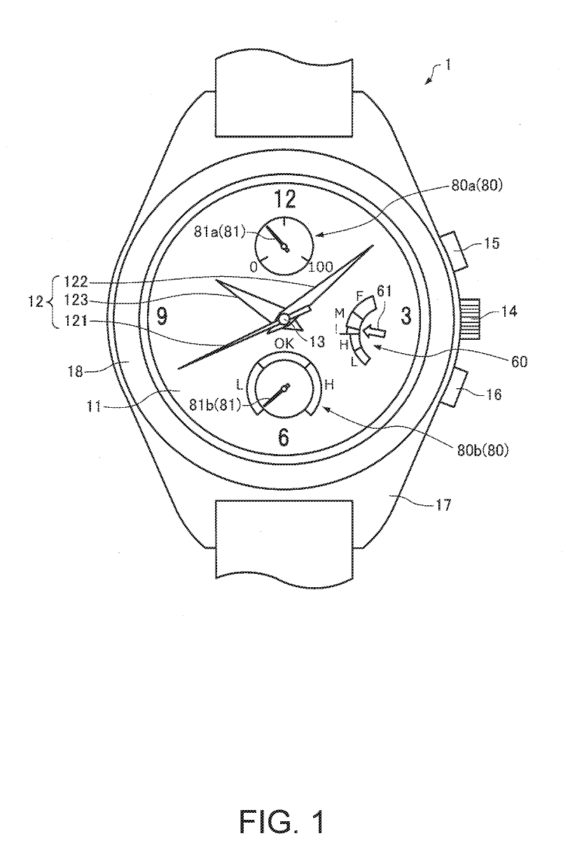

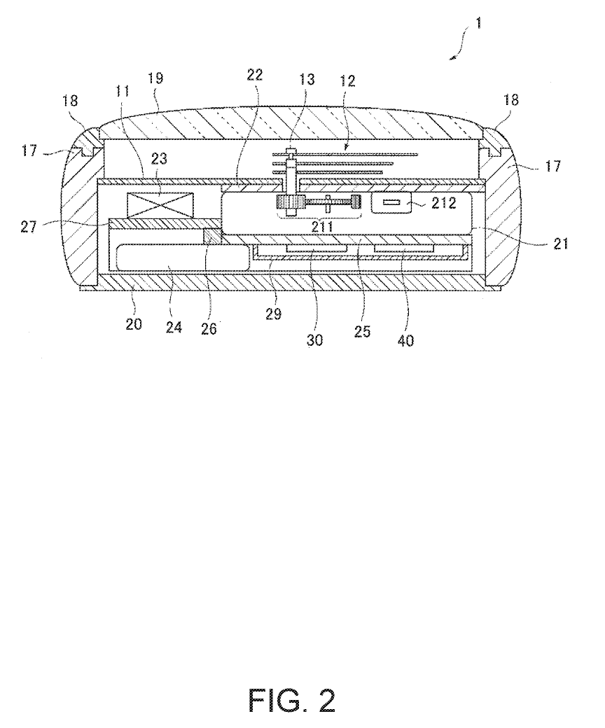

FIG. 1 is a plan view of an electronic timepiece 1 according to the present embodiment. FIG. 2 is a schematic cross-sectional view of the electronic timepiece 1. The electronic timepiece 1 is a wristwatch worn around a user's wrist, includes a dial 11 and indication hands 12 (121, 122, and 123), and measures and displays time. The indication hands 12 are provided on the front side of the dial 11. The indication hands 12 include a second hand 121, a minute hand 122, and an hour hand 123, which rotate around a rotary shaft 13, and are driven by a stepper motor via gears. The electronic timepiece 1 further includes an indicator hand 61, which forms a remaining amount display section 60, and indicator hands 81 (81a and 81b), which form a biological information display section 80 (80a and 80b). The indicator hands 61, 81a, and 81b are provided on the front side of the dial 11.

The electronic timepiece includes an exterior case 17 made of stainless steel, titanium, or any other metal material. The exterior case 17 is formed in a roughly cylindrical shape. A crown 14 and buttons 15 and 16, which from an operation section, are provided on the side surface of the exterior case 17. As shown in FIG. 2, a front-side glass plate 19 is attached via a bezel 18 to block a front-side opening of the exterior case 17. A movement 21, a solar cell 22, a GPS antenna 23, a wireless communication antenna, a secondary battery 24, a noncontact charging circuit, which is described later, and other components are disposed in the exterior case 17.

The movement 21 includes the stepper motor and a wheel train 211. The stepper motor is formed of a motor coil 212, a stator, a rotor, and other components and drives the indication hands 12 via the wheel train 211 and the rotary shaft 13.

A circuit substrate 25 is disposed on one side of the movement 21 and faces a case back 20. The circuit substrate 25 is connected to an antenna substrate 27 and the secondary battery 24 via a connector 26. The circuit substrate 25 is provided with a GPS reception circuit 30, which processes a signal received with the GPS antenna 23, a wireless communication circuit that processes information received with the wireless communication antenna, a variety of measurement circuits that perform a variety of measurement, a control circuit 40, which performs a variety of control, for example, drives and controls the stepper motor, and other circuits. The GPS reception circuit 30, the wireless communication circuit, the variety of measurement circuits, the control circuit 40, and other circuits are covered with a shield plate 29 and driven with electric power supplied from the secondary battery 24.

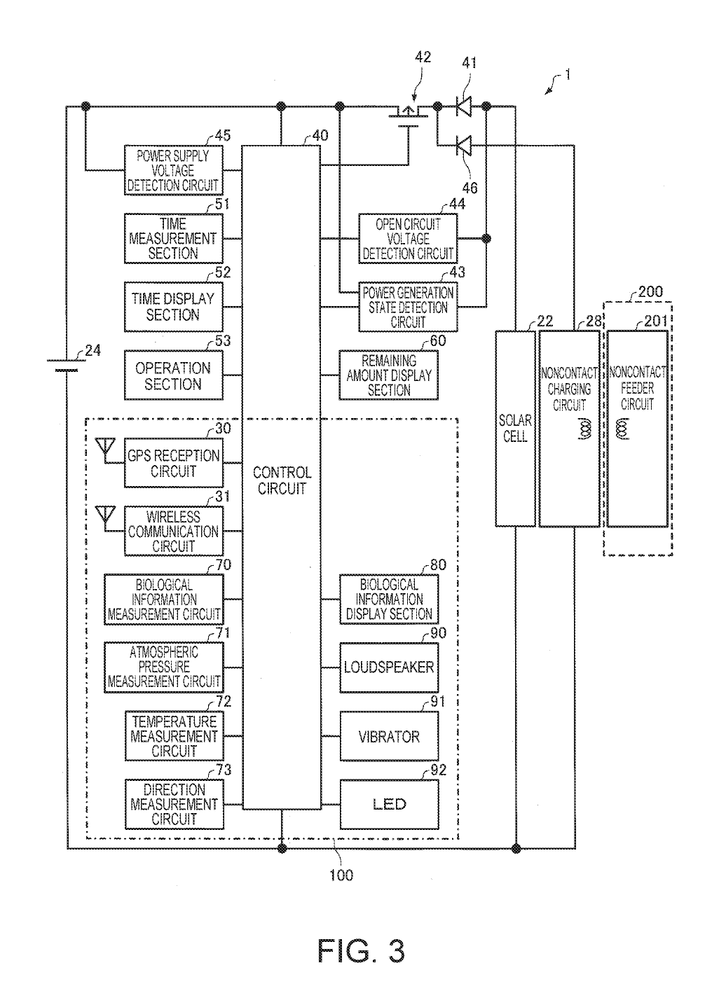

FIG. 3 is a block diagram showing a circuit configuration of the electronic timepiece 1. The electronic timepiece 1 according to the present embodiment may instead have a configuration in which part of the components in FIG. 3 is omitted.

The electronic timepiece 1 includes the solar cell 22 and the noncontact charging circuit 28, which are a plurality of charging sections, the secondary battery 24, the control circuit 40, which is a control section, diodes 41 and 46, a charging control switch 42, a power generation state detection circuit 43, an open circuit voltage detection circuit 44, a power supply voltage detection circuit 45, which is a voltage detection section, a time measurement section 51, a time display section 52, an operation section 53, the remaining amount display section 60, the GPS reception circuit 30, which functions as a reception section, the wireless communication circuit 31, a biological information measurement circuit 70, an atmospheric pressure measurement circuit 71, a temperature measurement circuit 72, a direction measurement circuit 73, the biological information display section 80, a loudspeaker 90 (sound output section), a vibrator 91, and an LED 92 (light source).

The solar cell 22 is a device that performs photoelectric power generation in which optical power is converted into electrical energy. The solar cell 22 has an electrode for outputting generated electric power and receives light having passed through the front-side glass plate 19 and the dial 11 to perform the photoelectric power generation.

The noncontact charging circuit 28 is a circuit that acquires electric power from an external apparatus 200 for a charging purpose (external power supply) and transmits electric power in a noncontact manner from a noncontact feeder circuit 201 of the external apparatus 200 for a charging purpose by using an electromagnetic induction method.

The secondary battery 24 is a power supply for the electronic timepiece 1 and is charged by the solar cell 22 and the noncontact charging circuit 28. That is, in the present embodiment, the solar cell 22 and the noncontact charging circuit 28 form the plurality of charging sections. The secondary battery 24 can, for example, be a lithium ion battery or a lithium polymer battery.

The control circuit 40 is formed of a CPU for controlling the electronic timepiece 1 and storage devices (RAM and ROM). The control circuit 40 controls action of the charging control switch 42, the power generation state detection circuit 43, the open circuit voltage detection circuit 44, the power supply voltage detection circuit 45, the time measurement section 51, the time display section 52, the remaining amount display section 60, the GPS reception circuit 30, the wireless communication circuit 31, the biological information measurement circuit 70, the atmospheric pressure measurement circuit 71, the temperature measurement circuit 72, the direction measurement circuit 73, the biological information display section 80, the loudspeaker 90, the vibrator 91, and the LED 92.

The diode 41 is provided in the path that electrically connects the solar cell 22 to the secondary battery 24 and does not block current from the solar cell 22 to the secondary battery 24 (forward current) but blocks current from the secondary battery 24 to the solar cell 22 (reverse current). The diode 46 is provided in the path that electrically connects the noncontact charging circuit 28 to the secondary battery 24 and does not block current from the noncontact charging circuit 28 to the secondary battery 24 (forward current) but blocks current from the secondary battery 24 to the noncontact charging circuit 28 (reverse current). The forward current flows only when the voltage across the solar cell 22 (noncontact charging circuit 28) is higher than the voltage across the secondary battery 24 (that is, at the time of charging). When the voltage across the solar cell 22 (noncontact charging circuit 28) is lower than the voltage across the secondary battery 24, the reverse current is blocked. The diodes 41 and 46 may be replaced with field effect transistors (FETs).

The charging control switch 42 enables and disables the current path from the charging sections (solar cell 22 and noncontact charging circuit 28) to the secondary battery 24 and has a switching device provided in the path that electrically connects the charging section to the secondary battery 24. For example, when the battery voltage across the secondary battery 24 is higher than or equal to a predetermined value, the charting control switch 42 keeps being turned off (the current path keeps being disabled) to avoid degradation of battery characteristics due to overcharging. The switching device is a p-channel transistor that operates in an ON-state when low-level gate voltage is applied whereas operating in an OFF-state when high-level gate voltage is applied. The gate voltage is controlled by the control circuit 40.

The power generation state detection circuit 43 operates in response to a control signal indicating charged state detection timing, detects the state of charging from the solar cell 22 to the secondary battery 24, and outputs a result of the detection to the control circuit 40. The open circuit voltage detection circuit 44 operates in response to a control signal indicating open circuit voltage detection timing, detects open circuit voltage across the solar cell 22 during a period in which the control signal keeps the charging control switch 42 in the OFF-state, and outputs a result of the detection to the control circuit 40. The power supply voltage detection circuit 45 detects the voltage across the secondary battery 24 (power supply voltage) and outputs a result of the detection to the control circuit 40.

The GPS reception circuit 30 receives a GPS satellite signal via the GPS antenna 23 and outputs acquired orbital information and time information to the control circuit 40.

The wireless communication circuit 31 performs short-range wireless communication (such as Bluetooth Low Energy (registered trademark), wireless LAN, and NFC) and transmits and receives information to and from an external apparatus (for example, mobile terminal, such as smartphone, and wireless LAN router) via the wireless communication antenna. The wireless communication circuit 31 further outputs time information received from an external apparatus and basic information necessary for biometrics (such as height, weight, and gender) to the control circuit 40. The wireless communication circuit 31 further transmits information measured by the biological information measurement circuit 70, the atmospheric pressure measurement circuit 71, the temperature measurement circuit 72, and the direction measurement circuit 73 to an external apparatus.

The time measurement section 51 includes a quartz oscillator or any other reference signal source that outputs a reference signal, a counter that counts the reference signal to measure time, and other components. The time measurement section 51 further functions as a time correction section and updates the counter based on the time information received by the GPS reception circuit 30 or the wireless communication circuit 31 to correct time.

The time display section 52 includes the movement 21 and moves the indication hands 12 to display the time measured by the time measurement section 51 on the front side of the electronic timepiece 1.

The operation section 53 includes the crown 14 and the buttons 15 and 16. When the crown 14 is operated, an action mode of the timepiece changes in accordance with the operation. For example, when the crown 14 is moved to a zero position, the time is displayed. When the crown 14 is moved to a first position, the displayed time is corrected. When the crown 14 is moved to a second position, the position of a reference hand is corrected. The operation section 53 further detects that any of the buttons 15 and 16 has been operated and outputs a detection signal to the control circuit 40.

The remaining amount display section 60 displays the amount of remaining battery voltage of the secondary battery 24 on the basis of the power supply voltage detected by the power supply voltage detection circuit 45. The remaining battery voltage is specifically displayed by using the indicator hand 61.

The biological information measurement circuit 70 measures biological information associated with the user who wears the electronic timepiece 1 (such as heart rate, pulse counts, breathing rate, blood pressure, blood sugar level, and body motion (motion of body)) and outputs a result of the measurement and information based on the result of the measurement (for example, number of steps, calorie consumption, amount of burned fat, and amounts of other types of activity) to the control circuit 40. The biological information measurement circuit 70 includes at least one of a heart rate sensor, a pulse sensor, a breathing sensor, a blood pressure sensor, a blood sugar sensor, and an acceleration sensor as a biometric sensor that measures the biological information.

The biological information display section 80 displays the biological information measured by the biological information measurement circuit 70 and information based on the measured biological information by using the indicator hands 81. A biological information display section 80a shown in FIG. 1 displays the number of steps based on acceleration detected with the acceleration sensor in the form of achievement (degree of achievement) with respect to a target number of steps per day. In the example shown in FIG. 1, the indicator hand 81a shows that about 35% of the target number of steps per day has been achieved. A biological information display section 80b shown in FIG. 1 displays the amount of burned fat based on the pulse counts detected with the pulse sensor. In the example shown in FIG. 1, the indicator hand 81b shows a small amount of burned fat (range labeled with “L” in FIG. 1). When the indicator hand 81b points a position in the range labeled with “H” in FIG. 1, a large amount of fat has been burned, and when the indicator hand 81b points a position in the range labeled with “OK” in FIG. 1, fat is burned at high efficiency.

The atmospheric pressure measurement circuit 71 includes an atmospheric pressure sensor that measures the atmospheric pressure and outputs a result of the measurement to the control circuit 40. The temperature measurement circuit 72 includes a temperature sensor that measures the temperature and outputs a result of the measurement to the control circuit 40. The direction measurement circuit 73 includes a direction sensor that measures the direction (terrestrial magnetism sensor) and outputs a result of the measurement to the control circuit 40.

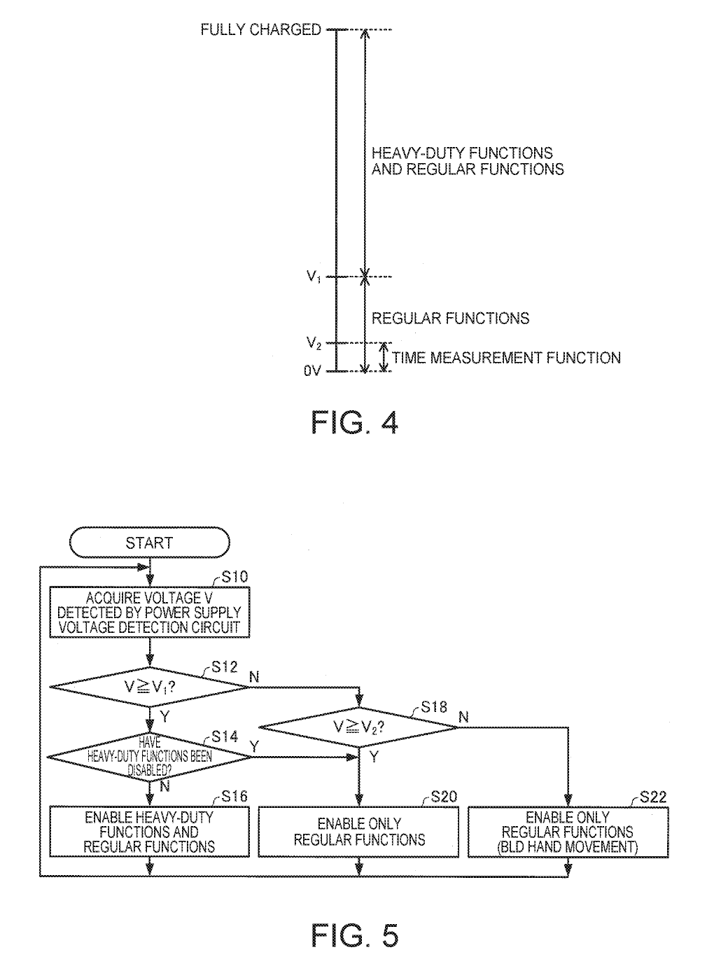

In the electronic timepiece 1 according to the present embodiment, the functions of the electronic timepiece 1 are divided into basic functions as a timepiece (regular functions) and functions that require a large amount of power consumption (heavy-duty functions), and the electronic timepiece 1 controls the functions thereof in such a way that the heavy-duty functions are enabled only when the voltage across the secondary battery 24 is higher than or equal to first voltage but the regular functions are enabled irrespective of the voltage across the secondary battery 24. That is, when the voltage across the secondary battery 24 is higher than or equal to first voltage V₁, the heavy-duty functions and the regular functions are enabled, whereas when the voltage across the secondary battery 24 is lower than the first voltage V₁, only the regular functions are enabled but the heavy-duty functions are disabled, as shown in FIG. 4.

Specifically, in FIG. 3, the functions enclosed by the dashed line (GPS reception circuit 30, wireless communication circuit 31, biological information measurement circuit 70, atmospheric pressure measurement circuit 71, temperature measurement circuit 72, direction measurement circuit 73, biological information display section 80, loudspeaker 90, vibrator 91, and LED 92) are set as heavy-duty functions 100, and the other components including the time measurement section 51 and the time display section 52 are set as the regular functions. When the voltage across the secondary battery 24 is lower than the first voltage V₁, the control circuit 40 stops outputting a control signal to each of the functions that belong to the heavy-duty functions 100 to disable the heavy-duty functions 100. The first voltage V₁ is set at a voltage value that allows the regular functions (time measurement section 51 and time display section 52, in particular) to be enabled only with electric power generated by the solar cell 22 without electric power charged from an external power supply via the noncontact charging circuit 28. For example, when the secondary battery 24 is a high-capacity secondary battery having capacity larger than that of a low-capacity secondary battery used in an electronic timepiece of related art provided with a solar cell but having no heavy-duty functions, the first voltage V₁ may be set to the upper limit of the voltage across the low-capacity secondary battery.

As described above, preventing the heavy-duty functions 100 from being enabled when the voltage across the secondary battery 24 is smaller than the first voltage V₁ allows the basic functions as a timepiece (time measurement function and time display function) to be maintained for a long period. Further, in the present embodiment, the secondary battery 24 can be charged with the solar cell 22 without use of any external power supply, and the secondary battery 24 can also be quickly charged by using an external power supply, whereby the secondary battery 24 can be charged as necessary even when the voltage across the secondary battery 24 is low to enable the heavy-duty functions 100.

Further, in the present embodiment, the control circuit 40 disables part of the function of the time display section 52 (but maintains time measurement function among regular functions) when the voltage across the secondary battery 24 is lower than second voltage V₂ (V₂<V₁), as shown in FIG. 4. For example, the control circuit 40 uses the second hand 121 to perform BLD hand movement (moves the second hand by the amount corresponding to two seconds every two seconds, for example) or perform powered hand movement (moves the second hand by the amount corresponding to five seconds every five seconds, for example) when the voltage across the secondary battery 24 is lower than second voltage V₂, and the control circuit 40 further causes the time display section 52 (movement 21) to stop operating when the voltage across the secondary battery 24 is lower than third voltage V₃ (V₃<V₂). The minimum function as a timepiece (time measurement function) can thus be maintained for a long period.

Further, in the present embodiment, the remaining amount display section 60 displays the amount of remaining battery voltage of the secondary battery 24 in the form of the relationship with the first voltage V₁. In the example shown in FIG. 1, when the indicator hand 61 points a position in the range above the horizontal line (ranges labeled with “F”, “M”, and “!” in FIG. 1), it is indicated that the battery voltage is higher than or equal to the first voltage V₁ (that is, the heavy-duty functions 100 can be enabled), whereas when the indicator hand 61 points a position in the range below the horizontal line (ranges labeled with “H” and “L” in FIG. 1), it is indicated that the battery voltage is lower than the first voltage V₁ (that is, only the regular functions can be enabled). When the indicator hand 61 points a position in the “F” range, it is indicated that the battery is roughly fully charged. When the indicator hand 61 points a position in the “M” range, it is indicated that the amount of remaining battery voltage is lower than those in the “F” range. When the indicator hand 61 points a position in the “!” range, it is indicated that the amount of remaining battery voltage is lower than those in the “M” range and approaches the first voltage V₁. When the indicator hand 61 points a position in the “H” range, it is indicated that the amount of remaining battery voltage is lower than the first voltage V₁ but higher than those in the “L” range. Using the indicator hand 61 to display the amount of remaining battery voltage of the secondary battery 24 in the form of the relationship with the first voltage V₁ allows the user to readily grasp whether or not the heavy-duty functions 100 can be enabled and how long the battery voltage lasts before the heavy-duty functions 100 are disabled (or how long the heavy-duty functions 100 are enabled).

Further, in the present embodiment, the user may be allowed to select (set) a mode in which the heavy-duty functions 100 are disabled even when the voltage across the secondary battery 24 is higher than or equal to the first voltage V₁ by the user's operation of the operation section 53 (buttons 15 and 16). That is, when the mode in which the heavy-duty functions 100 are disabled has been set by the user, the control circuit 40 controls the heavy-duty functions 100 to be disabled even when the voltage across the secondary battery 24 is higher than or equal to the first voltage V₁. In this case, the user may be allowed, by user's operation of the operation section 53, to set all the heavy-duty functions 100 to be disabled or select a function to be disabled from the heavy-duty functions 100. The user can thus select the mode in which the heavy-duty functions 100 are disabled under a circumstance in which the heavy-duty functions 100 are not required, whereby the basic functions as a timepiece can be maintained for a long period with no battery drain due to the heavy-duty functions 100.

When the electronic timepiece 1 is provided with an acceleration sensor, the control circuit 40 may control the heavy-duty functions 100 to be disabled even when the voltage across the secondary battery 24 is higher than or equal to the first voltage V₁ but when the acceleration sensor has detected no acceleration for a predetermined period. On the other hand, provided that the voltage across the secondary battery 24 is higher than or equal to the first voltage V₁, the control circuit 40 may control the heavy-duty functions 100 to be enabled when the acceleration sensor has detected acceleration.

FIG. 5 is a flowchart showing the procedure of the action of the control circuit 40. The control circuit 40 first acquires voltage V across the secondary battery 24 that has been detected by the power supply voltage detection circuit 45 (step S10) and evaluates whether or not the acquired voltage V is higher than or equal to the first voltage V₁ (step S12). When the voltage V is higher than or equal to the first voltage V₁ (Y in step S12), the control circuit 40 evaluates whether or not the mode in which the heavy-duty functions 100 are disabled has been set (step S14). When the mode has not been set (N in step S14), the control circuit 40 controls the heavy-duty functions 100 and the regular functions (time measurement section 51 and time display section 52) to be enabled (step S16).

When the voltage V is lower than the first voltage V₁ (N in step S12), the control circuit 40 evaluates whether or not the voltage V is higher than or equal to the second voltage V₂ (step S18). When the voltage V is higher than or equal to the second voltage V₂ (Y in step S18), and when the mode in which the heavy-duty functions 100 are disabled has been set (Y in step S14), the control circuit 40 controls only the regular functions to be enabled and stops outputting control signals to the heavy-duty functions 100 (step S20). When the voltage V is lower than the second voltage V₂ (N in step S18), the control circuit 40 controls only the regular functions to be enabled but part of the function of the time display section 52 to be disabled (for example, BLD hand movement is performed) (step S22).

The electronic timepiece 1 according to the present embodiment may include, as one of the plurality of charging sections (in place of the solar cell 22 or the noncontact charging circuit 28 or in addition thereto), a charging section that converts energy produced when the operation section 53 is operated into electric power for the charging. For example, the electronic timepiece 1 may include, as the charging section, a mechanism that generates electric power when the user rotates the crown 14, a mechanism that generates electric power when the user rotates the bezel 18, or a mechanism that generates electric power when the user pushes the buttons 15 and 16. Further, the electronic timepiece 1 may include, as one of the plurality of charging sections, a charging section that converts kinetic energy into electric power for the charging, for example, a mechanism that generates electric power when a power generating rotor (rotating weight) provided in the exterior case 17 rotates. Further, the electronic timepiece 1 may include, as one of the plurality of charging sections, a charging section that converts thermal energy into electric power for the charging, for example, a thermal power-generation device that uses the difference between the user's body temperature and the outdoor temperature to generate power. Still further, the electronic timepiece 1 may include, as one of the plurality of charging sections, a charging section that converts fuel energy, such as liquid or gaseous fuel energy, into electric power for the charging. Providing any of the charging sections described above allows the secondary battery 24 to be charged without use of any external power supply or under a weak external light condition, whereby the heavy-duty functions 100 can be enabled by charge of the secondary battery 24 as required even when the voltage across the secondary battery 24 is low.

Further, in the present embodiment, as the reception section, in place of the GPS reception circuit 30 or in addition thereto, a radio wave reception circuit that receives standard radio wave may be provided. In this case, the radio wave reception circuit outputs time information acquired from the received standard radio wave to the control circuit 40, and the time measurement section 51 updates the counter to correct time based on the time information acquired by the radio wave reception circuit.

Further, in the present embodiment, the time display section 52 may display time by using a liquid crystal display or any other display device (digital display) instead of (or in addition to) displaying time by using the indication hands 12 (analog display).

### Second Embodiment

In an electronic timepiece 1 according to a second embodiment, in addition to the regular functions in the first embodiment, the reception section (GPS reception circuit 30 or radio wave reception circuit) is set as another regular function. That is, the control circuit 40 enables the reception section irrespective of the voltage across the secondary battery 24, and the time measurement section 51 (time correction section) corrects time based on time information acquired by the GPS reception circuit 30 or the radio wave reception circuit even when the voltage across the secondary battery 24 is lower than the first voltage V₁.

In the second embodiment, the function of correcting time based on time information acquired by the GPS reception circuit 30 is set as a regular function, but functions of continuously performing positioning based on orbital information acquired by the GPS reception circuit 30 (navigation function, GPS log function, and functions that consume a large amount of electric power) are set as heavy-duty functions. The function of performing one-time positioning based on orbital information acquired by the GPS reception circuit 30 may, however, be set as a regular function.

As described above, setting the reception section and the time correction section as regular functions allows correct time measurement to be maintained by reception of radio wave containing time information even when the voltage across the secondary battery 24 decreases.

### Third Embodiment

In an electronic timepiece 1 according to a third embodiment, in addition to the regular functions in the first embodiment, the wireless communication circuit 31 is set as another regular function. That is, the control circuit 40 enables the wireless communication circuit 31 irrespective of the voltage across the secondary battery 24, and the time measurement section 51 (time correction section) corrects time based on time information received from an external apparatus by the wireless communication circuit 31 even when the voltage across the secondary battery 24 is lower than the first voltage v₁.

As described above, setting the wireless communication circuit 31 and the time correction section as regular functions allows correct time measurement to be maintained by use of time information received from an external apparatus even when the voltage across the secondary battery 24 decreases.

### Fourth Embodiment

In an electronic timepiece 1 according to a fourth embodiment, in addition to the regular functions in the first embodiment, each of the acceleration sensor and the wireless communication circuit 31 provided in the electronic timepiece 1 is set as another regular function. That is, the control circuit 40 enables the acceleration sensor and the wireless communication circuit 31 irrespective of the voltage across the secondary battery 24, and the biological information measurement circuit 70 measures the amount of activity based on the acceleration detected with the acceleration sensor even when the voltage across the secondary battery 24 is lower than the first voltage V₁, and the wireless communication circuit 31 transmits information on the measured amount of activity to an external apparatus, such as a smartphone. The information on the amount of activity received by the external apparatus is transmitted, for example, to a server on the Internet, and the server performs diagnosis or any other operation based on the information on the amount of activity. The server then transmits information on a result of the diagnosis to the external apparatus.

In the fourth embodiment, the function of measuring the amount of activity by using the acceleration sensor is set as a regular function, but the function of measuring biological information (heart rate, pulse counts, breathing rate, blood pressure, and blood sugar level) by using the other sensors provided in the biological information measurement circuit 70 is set as a heavy-duty function, as in the first embodiment.

As described above, setting the acceleration sensor and the wireless communication circuit 31 as regular functions allows maintenance of the function of contributing to management of the user's physical condition, such as the function of transmitting information on the amount of activity measured by using the acceleration sensor to an external apparatus, even in the case where the voltage across the secondary battery 24 decreases.

### Fifth Embodiment

An electronic timepiece 1 according to a fifth embodiment is configured so as to allow the user to operate the operation section 53 (buttons 15 and 16) to select a component to be set as a regular function from the atmospheric pressure measurement circuit 71, the temperature measurement circuit 72, the direction measurement circuit 73, and the pulse sensor. That is, when the user selects the atmospheric pressure measurement circuit 71 as a component to be set as a regular function, the control circuit 40 enables the atmospheric pressure measurement circuit 71 irrespective of the voltage across the secondary battery 24, and the atmospheric pressure measurement circuit 71 measures the atmospheric pressure automatically (at a fixed-interval measurement frequency) or manually (when operation section 53 is operated). When the user selects the temperature measurement circuit 72 as a component to be set as a regular function, the control circuit 40 enables the temperature measurement circuit 72 irrespective of the voltage across the secondary battery 24, and the temperature measurement circuit 72 automatically or manually measures the temperature. When the user selects the direction measurement circuit 73 as a component to be set as a regular function, the control circuit 40 enables the direction measurement circuit 73 irrespective of the voltage across the secondary battery 24, and the direction measurement circuit 73 automatically or manually measures the direction. When the user selects the pulse sensor as a component to be set as a regular function, the control circuit 40 enables the pulse sensor and the biological information display section 80b irrespective of the voltage across the secondary battery 24, and the pulse sensor automatically or manually measures the pulse counts and the biological information display section 80b displays information based on the pulse counts measured with the pulse sensor.

The configuration described above allows the user to select a function to be enabled irrespective of the voltage across the secondary battery 24 from the atmospheric pressure measurement, the temperature measurement, the direction measurement, and the pulse measurement, whereby the convenience of the user can be improved.

When the atmospheric pressure measurement circuit 71, to suppress power consumption, the temperature measurement circuit 72, or the pulse sensor is set as a regular function, the frequency of measurement using the circuit or sensor may be set to be lower than the measurement frequency in a case where the circuit or sensor is set as a heavy-duty function. For example, the atmospheric pressure measurement circuit 71 measures the atmospheric pressure at a frequency of three times per hour when it is set as a heavy-duty function, whereas measuring the atmospheric pressure at a frequency of once per hour when it is set as a regular function. The temperature measurement circuit 72 measures the temperature at a frequency of three times per hour when it is set as a heavy-duty function, whereas measuring the temperature at a frequency of twice per hour when it is set as a regular function.

Further, to suppress power consumption, the number of functions that can be simultaneously selected as regular functions from the atmospheric pressure measurement circuit 71, the temperature measurement circuit 72, the direction measurement circuit 73, and the pulse sensor may be limited to one. When the number of functions that can be selected as regular functions is set at two or more, the frequency of measurement using each of the circuits and the sensor may be further lowered, or the circuits and the sensor may only be allowed to perform manual measurement. Still further, a combination of functions that can keep operating even when the voltage across the secondary battery 24 is lower than the first voltage V₁ may be inferred, and only the combination of operable functions may be selected as a regular function.

When part of the heavy-duty functions 100 in the first embodiment is set as a regular function, as in the second to fifth embodiments, the power generation performance of the solar cell 22 is preferably increased because the power consumption in the case where the voltage across the secondary battery 24 is lower than the first voltage V₁ increases. For example, the power generation performance of the solar cell 22 can be increased by formation of the dial 11 by using a material having high light transmittance or an increase in size of the light reception area (outer shape) of the solar cell 22.

The technical range of the invention is not limited to the embodiments described above and can be changed as appropriate to the extent that the change does not depart from the substance of the invention.

The entire disclosure of Japanese Patent Application No. 2015-038293, filed Feb. 27, 2015 is expressly incorporated by reference herein.

What is claimed is:

1. An electronic timepiece comprising:
a secondary battery;
a plurality of charging sections that charge the secondary battery with electric power;
a time measurement section that is driven with the electric power from the secondary battery and measures time;
a biological sensor that is driven with the electric power from the secondary battery and measures information on a biological body to which the electronic timepiece is attached; and
a time display section that displays the time measured by the time measurement section.

2. The electronic timepiece according to claim 1,
further comprising a voltage detection section that detects voltage across the secondary battery,
wherein the biological sensor is enabled only when the voltage across the secondary battery is higher than or equal to first voltage, but the time measurement section and the time display section are enabled irrespective of the voltage across the secondary battery.

3. The electronic timepiece according to claim 2, further comprising:
a reception section that receives a radio wave containing time information; and
a time correction section that corrects the time based on the time information received by the reception section,
wherein the reception section and the time correction section are enabled irrespective of the voltage across the secondary battery.

4. The electronic timepiece according to claim 3,
wherein the reception section includes at least one of a GPS reception circuit that receives a GPS satellite signal and a radio wave reception circuit that receives a standard radio wave.

5. The electronic timepiece according to claim 2, further comprising:
a wireless communication circuit that transmits and receives information to and from an external apparatus; and
a time correction section that corrects the time based on time information received from the external apparatus,
wherein the wireless communication circuit and the time correction section are enabled irrespective of the voltage across the secondary battery.

6. The electronic timepiece according to claim 2, further comprising:
an acceleration sensor; and
a wireless communication circuit capable of transmitting information detected with the acceleration sensor to an external apparatus,
wherein the acceleration sensor and the wireless communication circuit are enabled irrespective of the voltage across the secondary battery.

7. The electronic timepiece according to claim 2, further comprising:
an operation section; and
at least one of an atmospheric pressure sensor, a temperature sensor, a direction sensor, and a pulse sensor,
wherein a sensor to be enabled irrespective of the voltage across the secondary battery is allowed to be selected by operation of the operation section from the atmospheric pressure sensor, the temperature sensor, the direction sensor, and the pulse sensor.

8. The electronic timepiece according to claim 2,
wherein when the voltage across the secondary battery is lower than second voltage lower than the first voltage, at least part of a function of the time display section is disabled.

9. The electronic timepiece according to claim 2, further comprising an operation section,
wherein even when the voltage across the secondary battery is higher than or equal to the first voltage, disablement of the biological sensor is allowed to be selected by operation of the operation section.

10. The electronic timepiece according to claim 2, further comprising a remaining amount display section that displays the amount of remaining battery voltage of the secondary battery in the form of a relationship with the first voltage.

11. The electronic timepiece according to claim 1,
wherein any one of the plurality of charging sections includes an operation section and converts energy produced by operation of the operation section into electric power for the charging.

12. The electronic timepiece according to claim 1,
wherein any one of the plurality of charging sections converts any one of optical energy, kinetic energy, thermal energy, and fuel energy into electric power for the charging.

13. The electronic timepiece according to claim 1,
wherein any one of the plurality of charging sections acquires electric power from an external power supply for the charging.

14. The electronic timepiece according to claim 1, further comprising a tubular case made of a metal material,
wherein the charging sections, the time measurement section, the biological sensor, and the time display section are disposed in the case, and
the time display section includes a dial and an indication hand.
